(19) United States
(12) Patent Application Publication
(10) Pub. No.: US 2010/0322300 A1
(43) Pub. Date: Dec. 23, 2010

(54) METHOD AND APPARATUS FOR ADAPTIVE FEATURE OF INTEREST COLOR MODEL PARAMETERS ESTIMATION

(76) Inventors: Zhen Li, Plainsboro, NJ (US); Xiaoan Lu, Princeton, NJ (US); Cristina Gomilla, Princeton, NJ (US)

Correspondence Address: Robert D. Shedd, Patent Operations;THOMSON Licensing LLC, P.O. Box 5312, Princeton, NJ, 08543-5312, US

(21) Appl. No.: 12/735,906

(22) PCT Filed: Mar. 18, 2008
(86) PCT No.: PCT/US2008/003522

§ 371 Date: Aug. 25, 2010

(51) Int. Cl. H04N 11/04; G06K 9/00

(52) U.S. Cl. 375/240.01; 382/162; 375/E07.026

(57) ABSTRACT

A method and apparatus for adaptive feature of interest color model parameters estimation are provided. The apparatus includes a feature of interest color model parameters estimator and a feature of interest detector. The feature of interest color model parameters estimator is for extracting at least one set of pixels from at least one image. The at least one set of pixels corresponds to a feature of interest. For each of the at least one set of pixels, the feature of interest color model parameters estimator models color components of pixels in the at least one set with statistical models, and estimates feature of interest color model parameters based on the modeled color components to obtain at least one estimated feature of interest color model. The feature of interest detector is for detecting feature of interest pixels from the at least one set of pixels using the at least one estimated feature of interest color model.

### TECHNICAL FIELD

The present principles relate generally to video encoding and, more particularly, to a method and apparatus for adaptive feature of interest color model parameters estimation.

### BACKGROUND

The color components of human skin tone pixels tend to occur in a limited region in a color space and can be approximated with certain statistical models that are referred to herein as skin color models. A robust and accurate skin color model is essential to applications where skin detection and skin classification are needed, such as hand tracking, face recognition, image and video data indexing and retrieval, image and video compression, and so forth. In the case of image and video compression algorithms, skin tone pixels can first be detected and then assigned higher coding priority levels to achieve higher visual quality. In the case of hand tracking or face recognition, skin tone pixels can first be detected and serve as candidates for further refined detection and recognition.

A typical application using such statistical skin models often assumes that the model parameters of the skin color model are temporally and spatially invariant. This assumption may not hold in a practical application due to many reasons. For example, there could be a greater variety in the targeted skins in different images and videos, or there could be a greater variety in the image and video acquisition conditions. One such example is the different lighting conditions when an image or video is captured. Such mismatch in skin color model parameters can cause highly inaccurate or erroneous detection results, with skin tone pixels being classified as non-skin tone pixels and vice versa.

The color components of human skin tone can be modeled with certain statistical distributions in a color space. While many color spaces can be used for the modeling, it has been found that the selection of color spaces have limited effect on the model accuracy. For illustrative purposes, the following discussion will involve the YUV color space. A typical skin color model regards human skin color components as a 2-D Gaussian distribution, which can be defined by the mean and covariance matrix of color components U and V as follows:

$$μ = ( \overline{U} , \overline{V} ) \\ Σ = [ \begin{matrix}{σ}_{U}^{2} & {σ}_{U V} \\ {σ}_{U V} & {σ}_{V}^{2}\end{matrix} ] \qquad ( 1 )$$

where μ and Σ are the mean and covariance matrix of a 2-D Gaussian probability density function p(x), Ū and V̅ are the mean of the U and V color components, respectively, σ_{U}² and σ_{V}² are the variance of the U and V color components, respectively, and σ_{UV} the covariance of the U and V color components.

The probability that a pixel with color components x=(u,v) is skin tone is represented as follows:

$$p ( x ) = \frac{1}{2 π \sqrt{\vert Σ \vert}} {e}^{- {d}^{2} ( x ) / 2} \qquad ( 2 )$$

where d(x) is called the Mahalanobis Distance, and may be represented as follows:

d(x)=\sqrt{(x−μ)^{T}Σ⁻¹(x−μ)} (3)

The skin model parameters μ and Σ are typically estimated after training on a skin database. The following parameters, corresponding to Equation (1) above, are widely used in video conferencing applications:

$$μ = ( 108.15 , 152.00 ) \\ Σ = [ \begin{matrix}55.77 & - 58.66 \\ - 58.66 & 85.27\end{matrix} ] \qquad ( 4 )$$

In a typical application, once the model parameters μ and Σ are decided, they are used for all the images or videos. However, such static parameters can result in mismatches when the true skin color model parameters are dynamically changing and differ from the static parameters. Such mismatch can cause highly inaccurate or erroneous detection results, with skin tone pixels being classified as non-skin tone pixels and vice versa.

As a consequence, there is a strong need for an approach that provides adaptive skin color model parameters estimation that suits images and videos with dynamically changing model parameters. More accurate skin color model parameters can significantly improve the detection results and, hence, the performance of the applications where such models are used.

Turning to FIG. 1, an exemplary skin detection method in accordance with the prior art is indicated generally by the reference numeral 100.

The method 100 includes a start block 105 that passes control to a loop limit block 110. The loop limit block 110 begins a loop that loops over each pixel in a picture using a variable i, wherein i has a value from 1 up to the # of pixels in the picture, and passes control to a function block 115. It is to be appreciated that while a picture is used with respect to the loop, other units such as, for example, image regions may also be used in accordance with the present principles, while maintaining the spirit of the present principles.

The function block 115 computes a skin tone probability p with the skin color model, and passes control to a decision block 120. The decision block 120 determines whether or not p is greater than a threshold. If so, then control is passed to a function block 125. Otherwise, control is passed to a function block 150.

The function block 125 designates the current pixel being evaluated as a skin tone pixel candidate, and passes control to a decision block 130. The decision block 130 determines whether or not there is any additional criterion (with respect to determining whether the current pixel us actually a skin tone pixel). If so, the control is passed to a function block 135. Otherwise, control is passed to a function block 155.

The function block 135 checks the additional criterion, and passes control to a decision block 140. The decision block 140 determines whether or not the current pixel passes the additional criterion used to determine whether the current pixel is actually a skin tone pixel. If so, the control is passed to a function block 145. Otherwise, control is passed to a function block 160.

The function block 145 designates the current pixel as a skin tone pixel, and passes control to a loop limit block 175. The loop limit block 175 ends the loop, and passes control to an end block 199.

The function block 150 designates the current pixel as a non skin tone pixel, and passes control to the loop limit block 175.

The function block 155 designates the current pixel as a skin tone pixel, and passes control to the loop limit block 175.

The function block 160 designates the current pixel as not a skin tone pixel, and passes control to the loop limit block 175.

The method 100 is performed in the pixel domain. For each pixel, its corresponding probability is computed by function block 115 using Equation (2).

### SUMMARY

These and other drawbacks and disadvantages of the prior art are addressed by the present principles, which are directed to a method and apparatus for adaptive feature of interest color model parameters estimation.

According to an aspect of the present principles, there is provided an apparatus for color detection. The apparatus includes a feature of interest color model parameters estimator and a feature of interest detector. The feature of interest color model parameters estimator is for extracting at least one set of pixels from at least one image. The at least one set of pixels corresponds to a feature of interest. For each of the at least one set of pixels, the feature of interest color model parameters estimator models color components of pixels in the at least one set with statistical models, and estimates feature of interest color model parameters based on the modeled color components to obtain at least one estimated feature of interest color model. The feature of interest detector is for detecting feature of interest pixels from the at least one set of pixels using the at least one estimated feature of interest color model.

According to another aspect of the present principles, there is provided a method for color detection. The method includes extracting at least one set of pixels from at least one image. The at least one set of pixels corresponds to a feature of interest. For each of the at least one set of pixels, the method further includes modeling color components of pixels in the at least one set with statistical models, estimating feature of interest color model parameters based on the modeled color components to obtain at least one estimated feature of interest color model, and detecting feature of interest pixels from the at least one set of pixels using the at least one estimated feature of interest color model.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a flow diagram for an exemplary skin color detection method in accordance with the prior art;

FIG. 2 is a block diagram for an exemplary apparatus for rate control to which the present principles may be applied in accordance with an embodiment of the present principles;

FIG. 3 is a block diagram for an exemplary predictive video encoder to which the present principles may be applied in accordance with an embodiment of the present principles;

FIG. 4 is a flow diagram for an exemplary method for adaptive feature of interest color model parameters estimation in accordance with an embodiment of the present principles;

FIG. 5 is a flow diagram for an exemplary method for adaptive skin color model parameter estimation in accordance with an embodiment of the present principles;

FIG. 6 is a flow diagram for another exemplary method for adaptive skin color model parameter estimation in accordance with an embodiment of the present principles; and

FIG. 7 is a flow diagram for an exemplary method for joint skin color model parameter estimation using multiple estimation methods in accordance with an embodiment of the present principles.

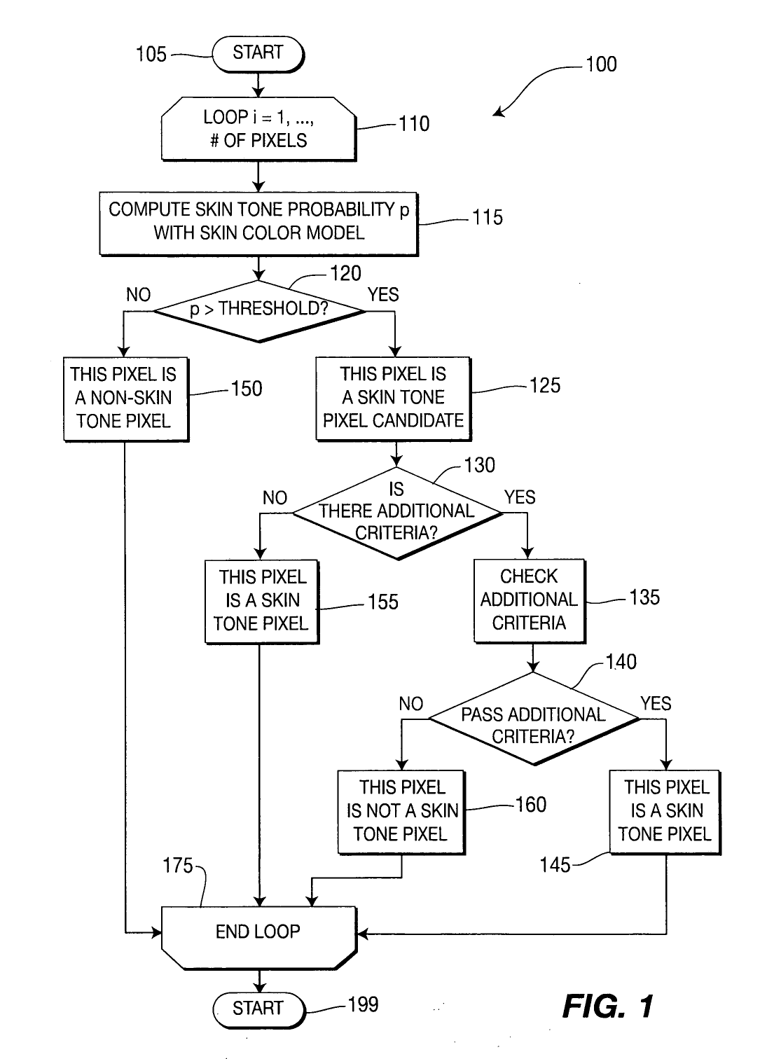

### DETAILED DESCRIPTION

The present principles are directed to a method and apparatus for adaptive feature of interest color model parameters estimation.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles means that a particular feature, structure, characteristic, and so forth described in connection with the embodiment is included in at least one embodiment of the present principles. Thus, the appearances of the phrase “in one embodiment” or “in an embodiment” appearing in various places throughout the specification are not necessarily all referring to the same embodiment.

It is to be appreciated that the use of the terms “and/or” and “at least one of”, for example, in the cases of “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

It is to be further appreciated that the present principles are not limited to any particular video coding standard, recommendation, and/or extension thereof. Thus, for example, the present principles may be used with, but is not limited to, the International Organization for Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 recommendation (hereinafter the “MPEG-4 AVC standard”), and the Society of Motion Picture and Television Engineers (SMPTE) Video Codec-1 (VC-1) Standard.

Moreover, it is to be appreciated that while one or more embodiments of the present principles are primarily described with respect to skin color, the present principles are generally applicable to the detection of any color set for a feature (also hereinafter interchangeably referred to as “feature of interest”) capable of being modeled. Thus, skin color is simply one example of a feature to which the present principles may be applied. For example, other embodiments of the present principles may be applied, but are not limited to, the following exemplary features: grass, sky, bricks, building materials of various types, and so forth. These and other features to which the present principles may be applied are readily contemplated by one of ordinary skill in this and related arts, while maintaining the spirit of the present principles.

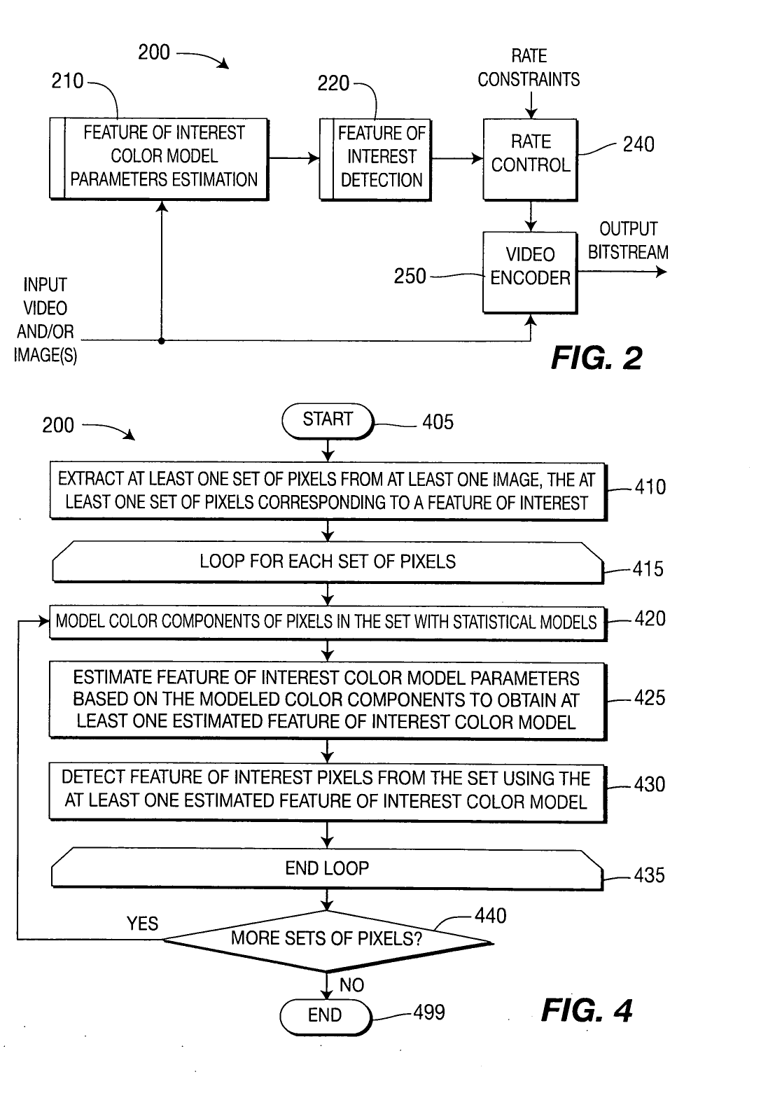

Turning to FIG. 2, an exemplary apparatus for rate control to which the present principles may be applied is indicated generally by the reference numeral 200. The apparatus 200 is configured to apply feature of interest (e.g., skin, grass, sky, and so forth) color model parameters estimation described herein in accordance with various embodiments of the present principles.

The apparatus 200 includes a feature of interest color model parameters estimator 210, a feature of interest detector 220, a rate controller 240, and a video encoder 250.

An output of the feature of interest color model parameters estimator 210 is connected in signal communication with an input of the feature of interest detector 220. An output of the feature of interest detector 220 is connected in signal communication with a first input of the rate controller 240. An output of the rate controller 240 is connected in signal communication with a first input of the video encoder 250.

An input of the feature of interest color model parameters estimator 210 and a second input of the video encoder are available as inputs of the apparatus 200, for receiving input video and/or image(s). A second input of the rate controller 240 is available as an input of the apparatus, for receiving rate constraints.

An output of the video encoder 250 is available as an output of the apparatus 200, for outputting a bitstream.

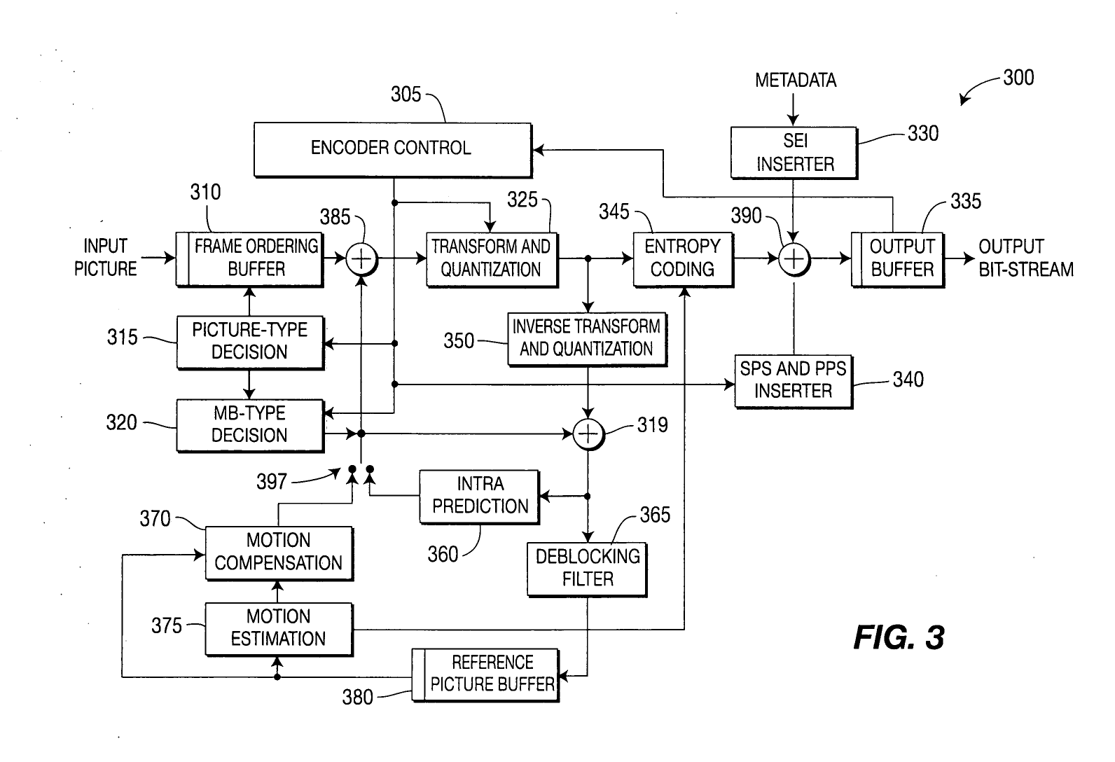

Turning to FIG. 3, an exemplary predictive video encoder to which the present principles may be applied is indicated generally by the reference numeral 300. The encoder 300 may be used, for example, as the encoder 250 in FIG. 2. In such a case, the encoder 300 is configured to apply the rate control (as per the rate controller 240) corresponding to the apparatus 200 of FIG. 2.

The video encoder 300 includes a frame ordering buffer 310 having an output in signal communication with a first input of a combiner 385. An output of the combiner 385 is connected in signal communication with a first input of a transformer and quantizer 325. An output of the transformer and quantizer 325 is connected in signal communication with a first input of an entropy coder 345 and an input of an inverse transformer and inverse quantizer 350. An output of the entropy coder 345 is connected in signal communication with a first input of a combiner 390. An output of the combiner 390 is connected in signal communication with an input of an output buffer 335. A first output of the output buffer is connected in signal communication with an input of the encoder controller 305.

An output of an encoder controller 305 is connected in signal communication with an input of a picture-type decision module 315, a first input of a macroblock-type (MB-type) decision module 320, a second input of the transformer and quantizer 325, and an input of a Sequence Parameter Set (SPS) and Picture Parameter Set (PPS) inserter 340.

A first output of the picture-type decision module 315 is connected in signal communication with a second input of a frame ordering buffer 310. A second output of the picture-type decision module 315 is connected in signal communication with a second input of a macroblock-type decision module 320.

An output of the Sequence Parameter Set (SPS) and Picture Parameter Set (PPS) inserter 340 is connected in signal communication with a third input of the combiner 390.

An output of the inverse quantizer and inverse transformer 350 is connected in signal communication with a first input of a combiner 327. An output of the combiner 327 is connected in signal communication with an input of an intra prediction module 360 and an input of the deblocking filter 365. An output of the deblocking filter 365 is connected in signal communication with an input of a reference picture buffer 380. An output of the reference picture buffer 380 is connected in signal communication with an input of the motion estimator 375 and a first input of a motion compensator 370. A first output of the motion estimator 375 is connected in signal communication with a second input of the motion compensator 370. A second output of the motion estimator 375 is connected in signal communication with a second input of the entropy coder 345.

An output of the motion compensator 370 is connected in signal communication with a first input of a switch 397. An output of the intra prediction module 360 is connected in signal communication with a second input of the switch 397. An output of the macroblock-type decision module 320 is connected in signal communication with a third input of the switch 397. An output of the switch 397 is connected in signal communication with a second input of the combiner 327.

An input of the frame ordering buffer 310 is available as input of the encoder 300, for receiving an input picture. Moreover, an input of the Supplemental Enhancement Information (SEI) inserter 330 is available as an input of the encoder 300, for receiving metadata. A second output of the output buffer 335 is available as an output of the encoder 300, for outputting a bitstream.

Turning to FIG. 4, an exemplary method for adaptive feature of interest color model parameters estimation is indicated generally by the reference numeral 400.

The method 400 includes a start block 405 that passes control to a function block 410. The function block 410 extracts at least one set of pixels from at least one image, the at least one set of pixels corresponding to a feature of interest, and passes control to a loop limit block 415. The loop limit block 415 begins a loop for each set of pixels, and passes control to a function block 420. The function block 420 models color components of pixels in the (current) set (being processed) with statistical models, and passes control to a function block 425. The function block 425 estimates feature of interest color model parameters based on the modeled color components to obtain at least one estimated feature of interest color model, and passes control to a function block 430. The function block 430 detects feature of interest pixels from the set using the at least one estimated feature of interest color model, and passes control to a loop limit block 435. The loop limit block ends the loop (over a current set), and passes control to a decision block 440. The decision block 440 determines whether or not there are any more sets of pixels. If so, the control is returned to the function block 420. Otherwise, control is passed to an end block 499.

As noted above, the present principles are directed to a method and apparatus for adaptive feature of interest color model parameters estimation. As noted above, skin color is but one exemplary feature of interest to which the present principles may be applied. Human skin color components generally fall into a limited region in a color space and can be approximated with certain statistical models, which are referred to herein as skin color models. Embodiments in accordance with the present principles consider the fact that skin color model parameters can vary for different images and videos.

In an embodiment, for every set of pixels, their corresponding skin color model parameters are estimated. Such set of pixels can be defined differently in different applications. As an example, such set of pixels can define a sub-set of a picture, an entire picture, a set of pictures, and so forth. A skin color model parameters estimation method may be applied to each set of pixels. Skin color model parameters estimation approaches are proposed. These skin color model parameters estimation approaches have the advantage of better capturing the skin color model characteristics of images and videos. That is, embodiments of the present principles provide more accurate and robust detection with adaptively estimated parameters.

In a first proposed method in accordance with an embodiment of the present principles, referred to herein as the Color Range method, the skin tone pixels are modeled as a Gaussian distribution and the model parameters are estimated from the regions in a color space where the skin pixels are likely to occur. In a second proposed method in accordance with an embodiment of the present principles, referred to herein as the Color Clustering method, the color components of all pixels are considered as a Gaussian mixture model. The Color Clustering method estimates the model parameters for each Gaussian model and then chooses one of them for the skin color model. A third proposed method in accordance with an embodiment of the present principles combines the estimation results from multiple estimation methods to further improve the estimation performance.

A pixel is classified as a skin tone pixel candidate if its corresponding probability is greater than a pre-determined threshold. Otherwise, the pixel is classified as a non-skin tone pixel. We note that while the luminance component of a pixel is not directly used in the above modeling, it can also be useful in skin pixel classification. In an embodiment, the luminance component of a pixel can be used to determine the lighting condition of a set of pixels. Once the lighting condition is decided, in an embodiment, a lighting compensation procedure may be used to adjust the values of the chrominance components for the pixels. Further refined criteria that consider other information including, but not limited to, size information, texture information, luminance information, motion information, and so forth, can be applied to skin tone pixel candidates to reduce the false positive detection (i.e., a non-skin tone pixel mistakenly classified as a skin tone pixel). The performance of such applications heavily depends on the skin color model parameters. When true skin color model parameters differ from the static model parameters, it will incur a penalty on the detection results.

### Color Range Method

For a set of pixels from which a skin color model is derived, the Color Range method proposed herein first collects all the pixels with color components in a pre-selected range, uₗ≦u≦uₕ and vₗ≦v≦vₕ. The thresholds uₗ, uₕ, vₗ and vₕ are selected such that a majority of skin tone pixels in practical applications can be included. Such thresholds can be theoretically derived or empirically trained. In an embodiment, such thresholds can be chosen such that a pre-determined percentage of skin tone pixels in an image or video database will be included inside this range. Denote N as the number of pixels that fall into this range. If N=0, then the Color Range method returns with null model parameters and a conclusion that there is no skin tone pixels in this set of pixels. If N>0, then the Color Range method estimates the mean and covariance matrix of these N pixels using a statistical estimation method. In an embodiment, such mean and covariance matrix can be estimated using the following equations:

$$\begin{matrix}( \hat{u} , \hat{v} ) = ( \frac{1}{N} {\sum }_{j = 1}^{N} {u}_{j} , \frac{1}{N} {\sum }_{j = 1}^{N} {v}_{j} ) & ( 5 ) \\ [ \begin{matrix}{\hat{σ}}_{u}^{2} & {\hat{σ}}_{u v} \\ {\hat{σ}}_{u v} & {\hat{σ}}_{v}^{2}\end{matrix} ] = [ \begin{matrix}\frac{1}{N} {\sum }_{j = 1}^{N} {( {u}_{j} - \hat{u} )}^{2} & \frac{1}{N} {\sum }_{j = 1}^{N} ( {u}_{j} - \hat{u} ) ( {v}_{j} - \hat{v} ) \\ \frac{1}{N} {\sum }_{j = 1}^{N} ( {u}_{j} - \hat{u} ) ( {v}_{j} - \hat{v} ) & \frac{1}{N} {\sum }_{j = 1}^{N} {( {v}_{j} - \hat{v} )}^{2}\end{matrix} ] & ( 6 )\end{matrix}$$

where (uᵢ,vᵢ) with i=1, . . . , N, are the color components of the pixels.

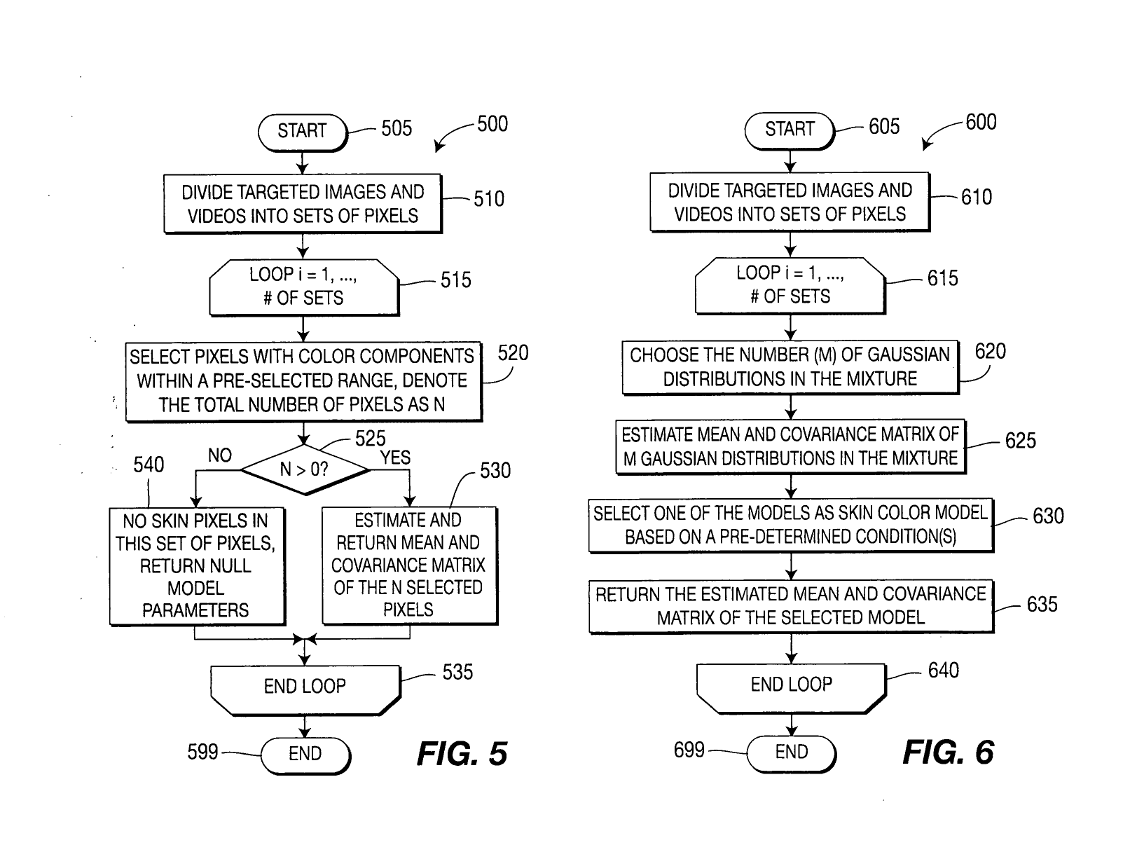

Turning to FIG. 5, an exemplary method for adaptive skin color model parameter estimation is indicated generally by the reference numeral 400. It is to be appreciated that the method 500 corresponds to the Color Range method described herein.

The method 500 includes a start block that passes control to a function block 510. The function block 510 divides targeted images and videos into sets of pixels, and passes control to a loop limit block 515. The loop limit block 515 begins a loop that loops over each set of pixels using a variable i, wherein i has a value from 1 up to the # of sets, and passes control to a function block 520. The function block 520 selects pixels with color components within a pre-selected range, denotes the total number of pixels as N, and passes control to a decision block 525. The decision block 525 determines whether or not N is greater than zero. If so, then control is passed to a function block 530. Otherwise, control is passed to a function block 540.

The function block 530 estimates and returns the mean and covariance matrix of the N selected pixels, and passes control to a loop limit block 535.

The loop limit block 535 ends the loop over each set of pixels, and passes control to an end block 599.

The function block 540 designates no skin pixels in the current set of pixels being evaluated, returns NULL model parameters, and passes control to the loop limit block 535.

### Color Clustering Method

The Color Clustering method models the color components of skin tone pixels in a set of pixels as a Gaussian distribution. The Color Clustering method also models the color components of non-skin tone pixels in a set of pixels as a mixture of Gaussian distributions. Hence, the color components in this set of pixels are a mixture of M Gaussian distributions. The Color Clustering method first collects the color component values for each pixel in this set of pixels, and then computes the mean and covariance matrix for each Gaussian distribution using statistical estimation methods. The value of M can be estimated using statistical estimation methods or pre-selected with empirical experiments. As a particular embodiment, such mean and covariance matrix can be estimated using an Expectation-Maximization (EM) algorithm as follows, presuming M is pre-selected and N represents the total number of pixels in the set:

1. Initialize each distribution with an arbitrary set of parameters μᵢ⁰, Σᵢ⁰, i=1, . . . , M

2. Update the parameters for i=1, . . . M with

$$\begin{matrix} {μ}_{i}^{t + 1} = \frac{{\sum }_{j = 1}^{N} {p}^{t} ( i \vert ( {u}_{j} , {v}_{j} ) ) ( {u}_{j} , {v}_{j} )}{{\sum }_{j = 1}^{N} {p}^{t} ( i \vert ( {u}_{j} , {v}_{j} ) )} & ( 7 ) \\ {Σ}_{i}^{t + 1} = \frac{{\sum }_{j = 1}^{N} {p}^{t} ( i \vert ( {u}_{j} , {v}_{j} ) ) [ \begin{matrix}{( {u}_{j} - {u}_{i}^{t} )}^{2} & ( {u}_{j} - {u}_{i}^{t} ) ( {v}_{j} - {v}_{i}^{t} ) \\ ( {u}_{j} - {u}_{i}^{t} ) ( {v}_{j} - {v}_{i}^{t} ) & {( {v}_{j} - {v}_{i}^{t} )}^{2}\end{matrix} ]}{{\sum }_{j = 1}^{N} {p}^{t} ( \vert ( {u}_{j} , {v}_{j} ) )} & ( 8 ) \\ {π}_{i}^{t + 1} = \frac{1}{N} {\sum }_{j = 1}^{N} {p}^{t} ( i \vert ( {u}_{j} , {v}_{j} ) ) & ( 9 ) \\ {p}^{t + 1} ( i \vert ( {u}_{j} , {v}_{j} ) ) = \frac{{p}^{t} ( ( {u}_{j} , {v}_{j} ) \vert i ) {π}^{t} ( i )}{{p}^{t} ( ( {u}_{j} , {v}_{j} ) )} & ( 10 )\end{matrix}$$

where the subscript t is the index after t times update, p(i|(uⱼ, vⱼ)) is the probability of a pixel belonging to the i-th distribution in the Gaussian mixture given its pixel value (uⱼ,vⱼ), πᵢ the percentage of pixels belonging to the i-th distribution in the Gaussian mixture.

3. Continue step 2 to update the parameters until the parameters converge or exit if the estimated parameters don't converge after K iterations with K pre-selected.

After the parameters of each model are estimated, one of the models will be selected as the skin color model for this set of pixels based on certain conditions. In an embodiment, such condition can be one that chooses the model with the maximum difference between the estimated mean of V and U, i.e., the maximum of \hat{v}−û. Of course, the present principles are not limited to solely the preceding selection criteria and, thus, other selection criteria may also be used to select a particular model, while maintaining the spirit of the present principles.

Turning to FIG. 6, another exemplary method for adaptive skin color model parameter estimation is indicated generally by the reference numeral 600. It is to be appreciated that the method 600 corresponds to the Color Clustering method described herein.

The method 600 includes a start block that passes control to a function block 610. The function block 610 divides targeted images and videos into sets of pixels, and passes control to a loop limit block 615. The loop limit block 615 begins a loop that loops over each set of pixels using a variable i, wherein i has a value from 1 up to the # of sets, and passes control to a function block 620. The function block 620 chooses the number (M) of Gaussian distributions in a mixture, and passes control to a function block 625. The function block 625 estimates the mean and covariance matrix of M Gaussian distributions in the mixture, and passes control to a function block 630. The function block 630 selects one of the models as a skin color model based on a pre-determined condition(s), and passes control to a function block 635. The function block 635 returns the estimated mean and covariance matrix of the selected model, and passes control to a loop limit block 640. The loop limit block 640 ends the loop over each set of pixels, and passes control to an end block 699.

Joint Estimation with Multiple Estimation Methods

In an embodiment, we also propose a method to combine the results of multiple skin color model parameter estimation methods. For L different skin color model parameter estimation methods, where each achieves the parameters estimation results \hat{μ}ᵢ and \hat{Σ}ᵢ, i=1, . . . , L, the final estimation results can be computed as a weighting average of these L results with weighting coefficients. Such weighting coefficients can be derived from equations or empirical experiments. In an embodiment, such weighting method can compute the estimated mean \hat{μ} as the arithmetic weighting mean of \hat{μ}ᵢ, i=1, . . . , L, and the estimated covariance \hat{Σ} as the geometric weighting mean of \hat{Σ}ᵢ, i=1, . . . , L, i.e., as follows:

$$\begin{matrix}\hat{μ} = \frac{{\sum }_{i = 1}^{L} {w}_{0 i} {\hat{μ}}_{i}}{L} & ( 11 ) \\ \hat{Σ} = {( {\prod }_{i = 1}^{L} {w}_{1 i} {\hat{Σ}}_{i} )}^{\frac{1}{L}} & ( 12 )\end{matrix}$$

where w₀ᵢ and w₁ᵢ are the weighting coefficients for the mean and covariance matrix respectively.

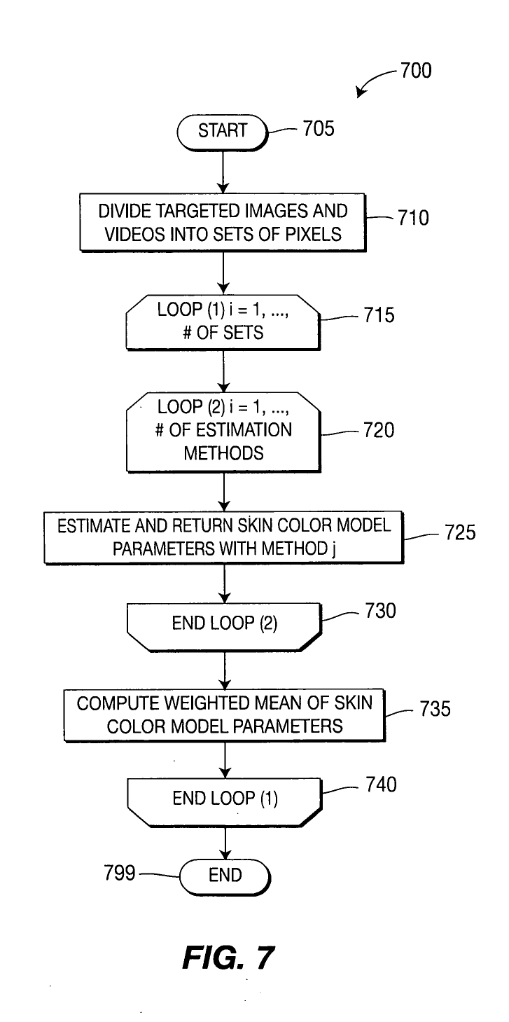

Turning to FIG. 7, an exemplary method for joint skin color model parameter estimation using multiple estimation methods is indicated generally by the reference numeral 600.

The method 700 includes a start block that passes control to a function block 710. The function block 710 divides targeted images and videos into sets of pixels, and passes control to a loop limit block 715. The loop limit block 715 begins a first loop that loops over each set of pixels using a variable i, wherein i has a value from 1 up to the # of sets, and passes control to a loop limit block 720. The loop limit block 720 begins a second loop over each estimation method to be used using a variable j, wherein j has a value from 1 up to the # of estimation methods to be used, and passes control to a function block 725. The function block 725 estimates and returns skin color model parameters with method j, and passes control to a loop limit block 730. The loop limit block 730 ends the second loop over each of the estimation methods, and passes control to a function block 735. The function block 735 computes the weighted mean of the skin color parameters, and passes control to a loop limit block 740. The loop limit block 740 ends the first loop over each set of pixels, and passes control to an end block 799.

A description will now be given of some of the many attendant advantages/features of the present invention, some of which have been mentioned above. For example, one advantage/feature is an apparatus for color detection, the apparatus having a feature of interest color model parameters estimator and a feature of interest detector. The feature of interest color model parameters estimator is for extracting at least one set of pixels from at least one image. The at least one set of pixels corresponds to a feature of interest. For each of the at least one set of pixels, the feature of interest color model parameters estimator models color components of pixels in the at least one set with statistical models, and estimates feature of interest color model parameters based on the modeled color components to obtain at least one estimated feature of interest color model. The feature of interest detector is for detecting feature of interest pixels from the at least one set of pixels using the at least one estimated feature of interest color model.

Another advantage/feature is the apparatus for color detection as described above, wherein each of the at least one set of pixels respectively corresponds to one of the at least one image.

Yet another advantage/feature is the apparatus for color detection as described above, wherein each of the at least one set of pixels respectively corresponds to a video scene including a number of pictures.

Still another advantage/feature is the apparatus for color detection as described above, wherein the feature of interest color model parameters estimator estimates the feature of interest color model parameters to also obtain at least one non-feature of interest color model. The at least one non-feature of interest color model is modeled as a Gaussian mixture.

A further advantage/feature is the apparatus for color detection as described above, wherein at least one of the at least one estimated feature of interest color model is modeled as a Gaussian distribution.

Moreover, another advantage/feature is the apparatus for color detection as described above, wherein the estimated feature of interest color model parameters, corresponding to the at least one of the at least one estimated feature of interest color model that is modeled as a Gaussian distribution, are so estimated with pixels in a pre-selected range.

Further, another advantage/feature is the apparatus for color detection as described above, wherein the pre-selected range is based on a pre-determined percentage of feature of interest pixels in a feature of interest database.

Also, another advantage/feature is the apparatus for color detection as described above, wherein the feature of interest color model parameters are chosen based upon a minimum difference between an estimated V color component and an estimated U color component.

Additionally, another advantage/feature is the apparatus for color detection as described above, wherein the feature of interest color model parameters are estimated using a Gaussian mixture model.

Moreover, another advantage/feature is the apparatus for color detection as described above, wherein the feature of interest color model parameters are estimated using multiple model parameter estimation methods.

Also, another advantage/feature is the apparatus for color detection as described above, wherein the feature of interest color model parameters estimated using the multiple model parameters estimation methods are jointly estimated to obtain final estimated parameters.

Additionally, another advantage/feature is the apparatus for color detection as described above, wherein the feature of interest color model parameters estimator weights a mean of the final estimated parameters using arithmetic weighting.

Moreover, another advantage/feature is the apparatus for color detection as described above, wherein the feature of interest color model parameters estimator weights a mean of the final estimated parameters using geometric weighting.

Further, another advantage/feature is the apparatus for color detection as described above, wherein the apparatus is utilized in a video encoder.

Also, another advantage/feature is the apparatus for color detection as described above, wherein the video encoder encodes the plurality of regions into a bitstream compliant with the International Organization for Standardization/International Electrotechnical Commission Moving Picture Experts Group-4 Part 10 Advanced Video Coding standard/International Telecommunication Union, Telecommunication Sector H.264 recommendation.

Additionally, another advantage/feature is the apparatus for color detection as described above, wherein the video encoder encodes the plurality of regions into a bitstream compliant with the Society of Motion Picture and Television Engineers Video Codec-1 Standard.

Moreover, another advantage/feature is the apparatus for color detection as described above, wherein the feature of interest includes at least one of skin, grass, and sky.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus for color detection, comprising:
an estimator for extracting a set of pixels from an image, the set of pixels corresponding to a feature of interest, said estimator operative to model color components of pixels in the set of pixels with statistical models, and estimate parameters based on the modeled color components to obtain an estimated feature of interest color model; and
a detector for detecting pixels from the set of pixels using the estimated color model.

2. The apparatus of claim 1, wherein the image is a portion of a video.

3. The apparatus of claim 1, wherein said estimator estimates the parameters to also obtain a non-feature of interest color model, the non-feature of interest color model being modeled as a Gaussian mixture.

4. The apparatus of claim 1, wherein the estimated feature of interest color model is modeled as a Gaussian distribution.

5. The apparatus of claim 4, wherein the parameters corresponding to the estimated feature of interest color model that is modeled as a Gaussian distribution, are estimated with pixels in a pre-selected range.

6. The apparatus of claim 5, wherein the pre-selected range is based on a pre-determined percentage of feature of interest pixels in a feature of interest database.

7. The apparatus of claim 6, wherein the parameters are chosen based upon a minimum difference between an estimated V color component and an estimated U color component.

8. The apparatus of claim 1, wherein the parameters are estimated using a Gaussian mixture model.

9. The apparatus of claim 1, wherein the parameters are estimated using multiple model parameter estimation methods.

10. The apparatus of claim 10, wherein the parameters estimated using the multiple model parameters estimation methods are jointly estimated to obtain final estimated parameters.

11. The apparatus of claim 10, wherein said estimator weights a mean of the final estimated parameters using arithmetic weighting.

12. The apparatus of claim 10, wherein said estimator weights a mean of the final estimated parameters using geometric weighting.

13. The apparatus of claim 1, wherein the apparatus is utilized in a video encoder.

14. The apparatus of claim 13, wherein said video encoder encodes the plurality of regions into a bitstream compliant with the International Organization for Standardization/International Electrotechnical Commission Moving Picture Experts Group-4 Part 10 Advanced Video Coding standard/International Telecommunication Union, Telecommunication Sector H.264 recommendation.

15. The apparatus of claim 13, wherein said video encoder encodes the plurality of regions into a bitstream compliant with the Society of Motion Picture and Television Engineers Video Codec-1 Standard.

16. The apparatus of claim 1, wherein the feature of interest comprises at least one of skin, grass, and sky.

17. A method for color detection, comprising:
extracting a set of pixels from an image,
modeling a color component of the set of pixels with a statistical model to generate a modeled color component;
estimating a parameter based on the modeled color component to obtain a first color model; and
detecting pixels from the set of pixels using the first color model.

18. The method of claim 17, wherein said estimating step further comprises the step of estimating the parameters to obtain a second color model, the second color model being modeled as a Gaussian mixture.

19. The method of claim 17, wherein first color model is modeled as a Gaussian distribution.

20. The method of claim 19, wherein parameters are estimated with pixels in a pre-selected range.

21. The method of claim 20, wherein the pre-selected range is based on a pre-determined percentage of feature of interest pixels in a feature of interest database.

22. The method of claim 21, wherein the parameters are chosen based upon a minimum difference between an estimated V color component and an estimated U color component.

23. The method of claim 17, wherein the feature of interest color model parameters are estimated using a Gaussian mixture model.

24. The method of claim 17, wherein the feature of interest color model parameters are estimated using multiple model parameter estimation methods.

25. The method of claim 24, wherein the feature of interest color model parameters estimated using the multiple model parameters estimation methods are jointly estimated to obtain final estimated parameters.

26. The method of claim 24, wherein a mean of the final estimated parameters is weighted using arithmetic weighting.

27. The method of claim 24, wherein a mean of the final estimated parameters is weighted using geometric weighting.

28. The method of claim 17, wherein the method is utilized in a video encoder.

29. The method of claim 28, wherein the video encoder encodes the plurality of regions into a bitstream compliant with the International Organization for Standardization/International Electrotechnical Commission Moving Picture Experts Group-4 Part 10 Advanced Video Coding standard/International Telecommunication Union, Telecommunication Sector H.264 recommendation.

30. The method of claim 28, wherein the video encoder encodes the plurality of regions into a bitstream compliant with the Society of Motion Picture and Television Engineers Video Codec-1 Standard.

31. The method of claim 17, wherein the pixels comprise at least one of skin, grass, and sky.
